(19) United States
(12) Patent Application Publication
(10) Pub. No.: US 2019/0041723 A1
(43) Pub. Date: Feb. 7, 2019

(54) MONITORING CAMERA, AND MONITORING CAMERA SYSTEM PROVIDED WITH SAME

(71) Applicant: PANASONIC INTELLECTUAL PROPERTY MANAGEMENT CO., LTD., Osaka (JP)

(72) Inventor: Takeshi FUJIMATSU, Kanagawa (JP)

(73) Assignee: PANASONIC INTELLECTUAL PROPERTY MANAGEMENT CO., LTD., Osaka (JP)

(21) Appl. No.: 16/075,478

(22) PCT Filed: Feb. 20, 2017
(86) PCT No.: PCT/JP2017/006102

§ 371 Date: Aug. 3, 2018

(30) Foreign Application Priority Data
Mar. 11, 2016 (JP) 2016-048476

(51) Int. Cl. G03B 7/28; G06T 7/73; H04N 5/232; G06T 7/246; G08B 21/18

(52) U.S. Cl. CPC G03B 7/28; G06T 7/74; H04N 5/23216; G06T 2207/30232; H04N 5/23206; G08B 21/18; G06T 7/246

(57) ABSTRACT

There is provided a monitoring camera having an exposure control function, the camera appropriately executing exposure control even in a case where a deviation occurs in a reference area for exposure control that is set in a part of an imaging range due to an unintended viewing angle deviation. The monitoring camera includes: an exposure controller that executes exposure control by referring to a reference area which is set in a part of an imaging range; a change detector that detects a change in the reference area; and an area setter that sets a replacement area for replacing the reference area in a case where a change in the reference area is detected. The exposure controller executes the exposure control by referring to the replacement area in a case where the replacement area is set.

### TECHNICAL FIELD

The present disclosure relates to a monitoring camera having an exposure control function and a monitoring camera system including the monitoring camera.

### BACKGROUND ART

In the related art, in a monitoring camera that captures an image of a predetermined monitoring area, in order to appropriately capture an image of an object as an imaging target (for example, a person passing through the monitoring area), a technique of executing exposure control according to a change in imaging environment (for example, a change in condition where external light or illumination light is incident), is known. In exposure control, in order to prevent an occurrence of so-called white halation in a case where an object is relatively bright and an occurrence of so-called blackening in a case where an object is relatively dark, appropriate exposure adjustment is performed based on brightness of the object, sensitivity of an image sensor, or the like. In addition, for exposure control, a user can designate a photometric area for measuring brightness of an imaging target by, for example, operating an operation button of the camera or the like.

On the other hand, setting of the photometric area by the operation button or the like is very troublesome for a user, and thus a technique for setting the photometric area more easily has been developed. For example, there is a technique of providing a touch panel attached to a monitor for displaying captured images, performing adjustment of the photometric area by designating the photometric area on the touch panel within a range displayed on the monitor, and displaying the designated area on the monitor by superimposing the designated area on a video signal (refer to PTL 1).

### CITATION LIST

### Patent Literature

PTL 1: JP-A-2004-40162

### SUMMARY OF THE INVENTION

On the other hand, in the monitoring camera described in PTL 1, when an unintended force acts on a camera body (for example, contact with a moving object) and a viewing angle deviation occurs with respect to an initial viewing angle at which the photometric area is set, a deviation may also occur in the photometric area (reference area for exposure control) which is set by a user. In such a case, brightness of the photometric area varies based on a change in condition where external light or illumination light is incident on the monitoring area, and as a result, it may be difficult to perform exposure control for appropriately capturing the object.

The present disclosure has been made in view of such a problem in the related art, and an object of the present disclosure is to provide a monitoring camera and a monitoring camera system including the monitoring camera capable of appropriately executing exposure control even in a case where a deviation occurs in the reference area for exposure control that is set in a part of the imaging range due to an unintended viewing angle deviation.

According to the present disclosure, there is provided a monitoring camera having an exposure control function, the camera including: an exposure controller that executes exposure control by referring to a reference area which is set in a part of an imaging range; a change detector that detects a change in the reference area; and an area setter that sets a replacement area for replacing the reference area in a case where a change in the reference area is detected, in which the exposure controller executes the exposure control by referring to the replacement area in a case where the replacement area is set.

According to the present disclosure, it is possible to appropriately execute exposure control even in a case where a deviation occurs in the reference area for exposure control that is set in a part of the imaging range due to an unintended viewing angle deviation.

### BRIEF DESCRIPTION OF DRAWINGS

FIG. 1 is a configuration diagram illustrating an outline of monitoring camera system 1 according to a first embodiment.

FIG. 2 is a block diagram illustrating a configuration of monitoring camera 2 illustrated in FIG. 1.

FIG. 3 is an explanatory diagram illustrating an example of reference area A0 which is set in an imaging range of monitoring camera 2.

FIG. 4 is an explanatory diagram illustrating an example of a setting method of reference area A0 illustrated in FIG. 3.

FIG. 5 is an explanatory diagram illustrating an example of a change in reference area A0.

FIG. 6 is an explanatory diagram illustrating a correction result (replacement area A1) of reference area A0.

FIG. 7 is an explanatory diagram illustrating an example of a method for notifying a user of correction of reference area A0.

FIG. 8 is an explanatory diagram illustrating an example of a method for notifying a user of resetting of reference area A0.

FIG. 9 is a flowchart illustrating a flow of correction processing of reference area A0 in monitoring camera system 1.

FIG. 10A is an explanatory diagram illustrating a state before a change of reference line L0 which is set in an imaging range of monitoring camera 2 according to a second embodiment.

FIG. 10B is an explanatory diagram illustrating a state after a change of reference line L0 which is set in an imaging range of monitoring camera 2 according to the second embodiment.

FIG. 11 is an explanatory diagram illustrating a correction result (replacement line L1) of the reference line.

### DESCRIPTION OF EMBODIMENTS

In order to solve the problem, according to a first disclosure, there is provided a monitoring camera having an exposure control function, the camera including: an exposure controller that executes exposure control by referring to a reference area which is set in a part of an imaging range; a change detector that detects a change in the reference area; and an area setter that sets a replacement area for replacing the reference area in a case where a change in the reference area is detected, in which the exposure controller executes the exposure control by referring to the replacement area in a case where the replacement area is set.

According to the monitoring camera of the first disclosure, in a case where a change in the reference area is detected, exposure control is executed with reference to the replacement area. Thus, even in a case where a deviation occurs in the reference area for exposure control that is set in a part of the imaging range due to an unintended viewing angle deviation, it is possible to appropriately execute exposure control.

In addition, according to a second disclosure, in the monitoring camera of the first disclosure, the change detector detects a change in the reference area based on a change of a still object which exists as an object in the reference area.

According to the monitoring camera of the second disclosure, it is possible to detect a change in the reference area by a simple method.

In addition, according to a third disclosure, in the monitoring camera of the second disclosure, the change of the still object is displacement of the still object in the imaging range, and the area setter sets the replacement area based on the displacement of the still object.

According to the monitoring camera of the third disclosure, it is possible to recognize a direction and an amount of the viewing angle deviation (that is, a position of the still object which exists in the reference area) based on the displacement of the still object, and thus, it is possible to easily and appropriately set the replacement area.

In addition, according to a fourth disclosure, in the monitoring camera of the third disclosure, the area setter sets the replacement area only in a case where at least a part of the still object exists in the imaging range.

According to the monitoring camera of the fourth disclosure, the replacement area is set only in a case where the still object which exists in the reference area exists in the imaging range, and thus, it is possible to stably set the replacement area at an appropriate position.

In addition, according to a fifth disclosure, the monitoring camera of any one of the first disclosure to the fourth disclosure further includes an image storage unit that stores a reference image obtained by capturing a state before the change in the reference area, and the change detector detects a change in the reference area based on a difference between pixel values of a current captured image and the reference image.

According to the monitoring camera of the fifth disclosure, it is possible to detect a change in the reference area by simple processing.

In addition, according to a sixth disclosure, in the monitoring camera of any one of the first disclosure to the fifth disclosure, a plurality of division areas are set in the imaging range, and the reference area is configured with one or more division areas selected based on a user operation.

According to the monitoring camera of the sixth disclosure, a user can easily set the reference area by selecting the division area.

In addition, according to a seventh disclosure, the monitoring camera of any one of the first disclosure to the sixth disclosure further includes a notifier that prompts a user to reset the reference area in a case where a change in the reference area is detected and the replacement area is not set by the area setter.

According to the monitoring camera of the seventh disclosure, even in a case where it is difficult to automatically set the replacement area by an amount and a direction of the viewing angle deviation, a user can quickly reset the reference area.

In addition, according to an eighth disclosure, in the monitoring camera of any one of the first disclosure to the seventh disclosure, a reference line for determining passage of a moving object is set in the imaging range, and the area setter sets a replacement line for replacing the reference line in a case where a change in the reference area is detected.

According to the monitoring camera of the eighth disclosure, even in a case where a deviation occurs in the reference line for determining passage of a moving object due to a viewing angle deviation, it is possible to appropriately determine passage of a moving object based on the replacement line.

In addition, according to a ninth disclosure, there is provided a monitoring system including: the monitoring camera of any one of the first disclosure to the eighth disclosure; and an information device that is used for a setting operation by a user to the monitoring camera.

According to the monitoring system of the ninth disclosure, in a case where a change in the reference area is detected, exposure control is executed with reference to the replacement area. Thus, even in a case where a deviation occurs in the reference area for exposure control that is set in a part of the imaging range due to an unintended viewing angle deviation, it is possible to appropriately execute exposure control.

Hereinafter, embodiments according to the present disclosure will be described with reference to the drawings.

### First Embodiment

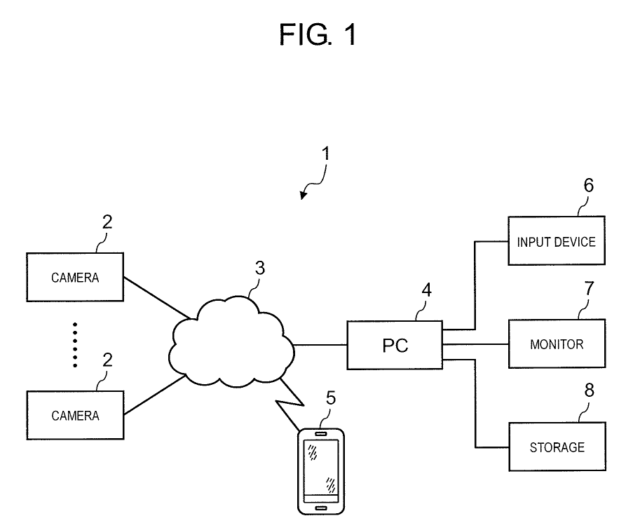

FIG. 1 is a configuration diagram illustrating an outline of monitoring camera system 1 according to a first embodiment of the present disclosure. Monitoring camera system 1 is a system for monitoring a moving object (for example, a person) or the like in a predetermined monitoring area, and includes a plurality of monitoring cameras 2 that generate captured images of a monitoring area, PC (information device) 4 that is communicably connected to monitoring cameras 2 via network 3 such as Internet and is used for a setting operation or the like by a user using monitoring cameras 2, and the like.

Monitoring camera 2 is a network camera having an IP communication function, and is provided at any place required for monitoring of a public facility, an office, or the like. An imaging range with a desired viewing angle is set in a monitoring area of monitoring camera 2. Monitoring camera 2 can transmit a captured image (a moving image or a still image) to PC 4, portable terminal (information device) 5 such as a mobile phone (smartphone), a tablet PC, or a PDA possessed by a user, a recorder (not illustrated), or the like as appropriate. The number and arrangement of monitoring cameras 2 in monitoring camera system 1 are not limited to the example illustrated in FIG. 1, and various modifications may be made.

PC 4 is a computer including known hardware (not illustrated in FIG. 1). Although not illustrated in FIG. 1, PC 4 includes a processor that integrally executes processing relating to monitoring camera 2 based on a predetermined control program (various settings relating to imaging, image processing, image display, and the like), a random access memory (RAM) that is a volatile memory functioning as a work area of the processor, a read only memory (ROM) that is a nonvolatile memory for storing control programs to be executed by the processor and data, a network interface (I/F) that is configured with a network adapter for connection to network 3, and the like. In addition, in PC 4, as peripheral devices, input device 6 that is configured with a keyboard, a mouse, and the like for allowing a user to perform an input operation, monitor 7 that displays captured images obtained by monitoring camera 2 and setting information of monitoring camera 2 to a user, storage 8 that stores the captured images and the setting information, and the like are provided.

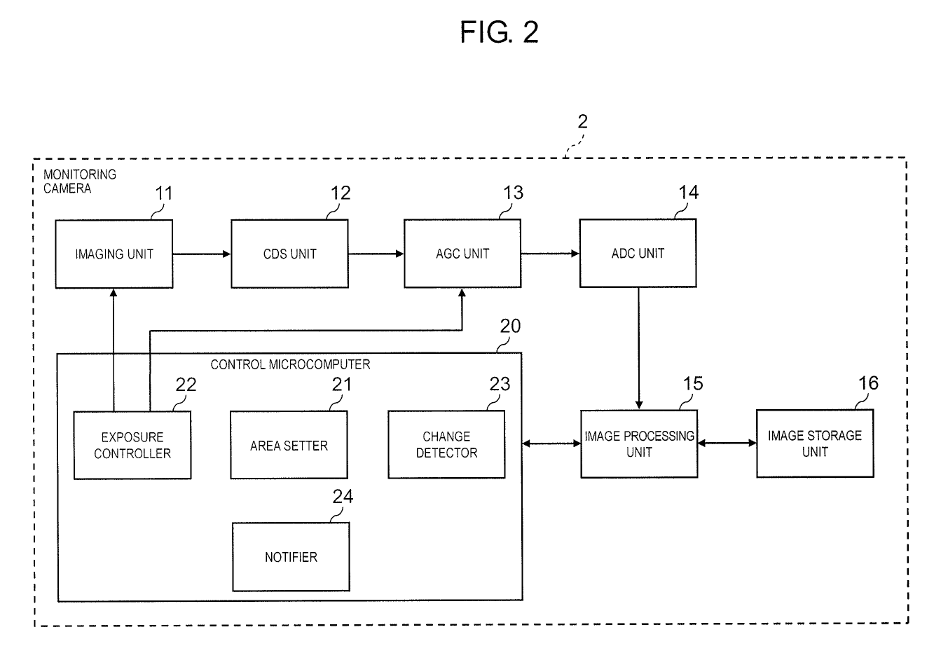

FIG. 2 is a block diagram illustrating a configuration of monitoring camera 2 illustrated in FIG. 1. Monitoring camera 2 includes imaging unit 11 that includes an image sensor such as a well-known CCD, correlated double sampling (CDS) unit 12 that performs processing for reducing noise of an output signal from imaging unit 11, automatic gain control (AGC) unit 13 that maintains a constant output level by amplifying a gain of the output signal, analog to digital converter (ADC) unit 14 that converts an analog signal into a digital signal, image processing unit 15 including an image processing processor which executes processing such as white balance adjustment processing, contour correction processing, or gamma correction processing, and outputs the image signal as a predetermined video signal, and image storage unit 16 configured with a nonvolatile memory which stores the captured image processed by image processing unit 15.

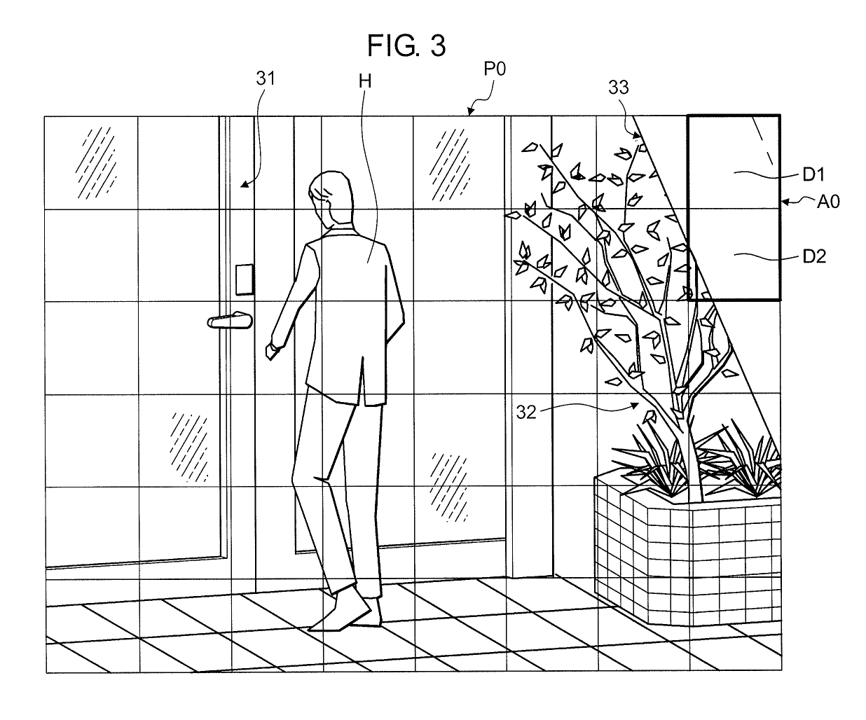

In addition, control microcomputer 20 is provided in monitoring camera 2, and control microcomputer 20 includes area setter 21 that sets reference area A0 (refer to FIG. 3) as a photometric area for exposure control in a part of the imaging range based on an setting operation by a user, exposure controller 22 that executes exposure control with reference to reference area A0, change detector 23 that detects a change in reference area A0, and notifier 24 that notifies a user of information relating to setting of reference area A0.

By referring to brightness data of reference area A0, exposure controller 22 executes exposure control based on a known technique. For example, exposure controller 22 can control exposure based on control of an electronic shutter (or a mechanical shutter) of the image sensor of imaging unit 11, or gain control of AGC unit 13.

Change detector 23 stores the captured image at the initial stage (that is, before a viewing angle deviation occurs) when reference area A0 is set, in image storage unit 16, as a reference image. Thus, change detector 23 can detect a change in reference area A0 caused by a viewing angle deviation of monitoring camera 2, based on a difference between pixel values of each of the reference image and the current image in reference area A0. Alternatively, change detector 23 can detect displacement of a still object (that is, a change in the reference area) by executing processing of extracting the still object from reference area A0 based on one or a plurality of reference images and performing known template matching processing of the still object in the reference area of the current captured image.

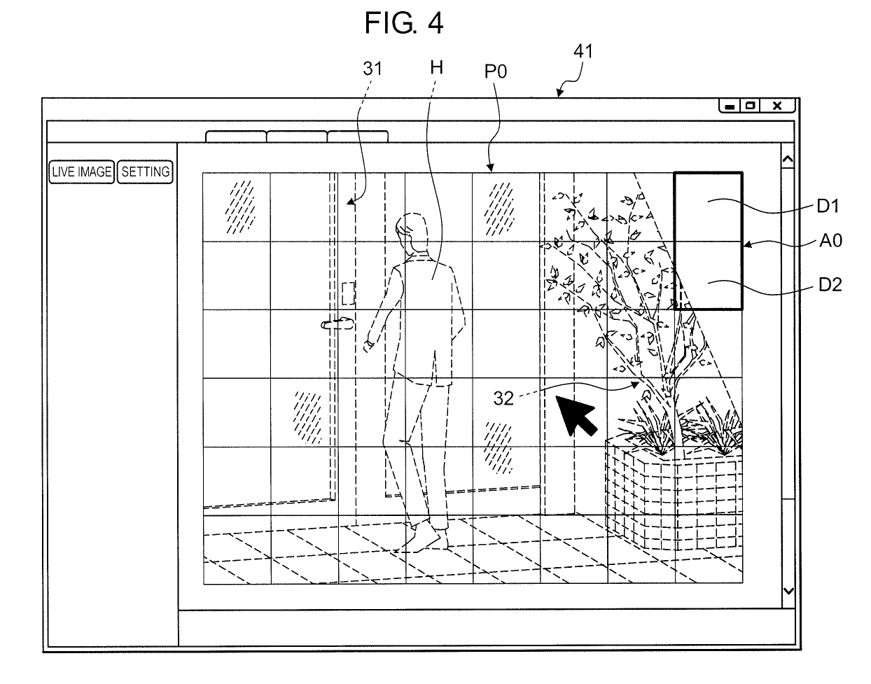

FIG. 3 is an explanatory diagram illustrating an example of reference area A0 which is set in the imaging range of the monitoring camera, and FIG. 4 is an explanatory diagram illustrating an example of a setting method of reference area A0 illustrated in FIG. 3.

In the example of FIG. 3, an entrance of a building is set as a monitoring area, and in captured image P0 based on a normal viewing angle (that is, before a viewing angle deviation occurs), person H, door 31 through which person H enters, foliage plant 32, a part of pillar 33 extending obliquely upward in front of door 31, and the like are included. In addition, captured image P0 (that is, imaging range) is divided into a plurality of rectangular division areas (virtual areas). Here, reference area A0 for exposure control is configured with two division areas D1 and D2 that are connected to each other in a vertical direction and are positioned at an upper right corner of captured image PO. In other words, reference area A0 is set in an area which is relatively unlikely to be influenced by incident light from the outside of the building (in this case, an area including pillar 33 as a standing still object). Thus, even when incident light from door 31 or window glass (not illustrated) changes due to weather or time elapse (day or night), monitoring camera 2 can prevent an occurrence of white halation or blackening without being significantly influenced by the change of incident light.

In addition, a user can set (or change) reference area A0 via PC 4 or mobile terminal 5. As illustrated in FIG. 4, for example, a user can set reference area A0 by performing an operation of selecting a desired division area (here, division areas D1 and D2) while checking captured image P0 on operation window 41 by an application program for monitoring camera 2. The shape, the size, and the number of division areas D1 and D2 are not limited to the example illustrated in FIG. 4, and various modifications may be made.

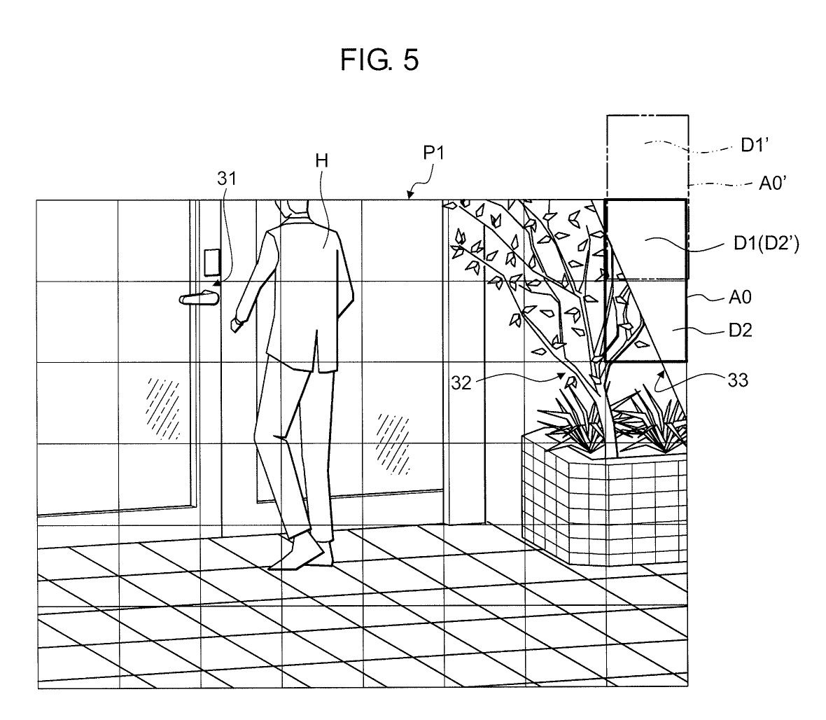

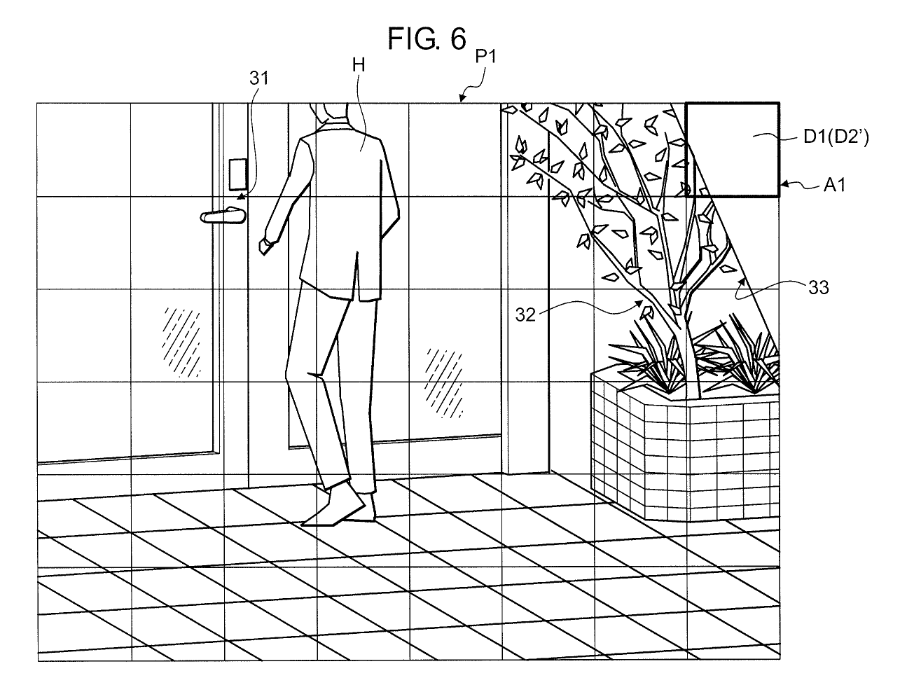

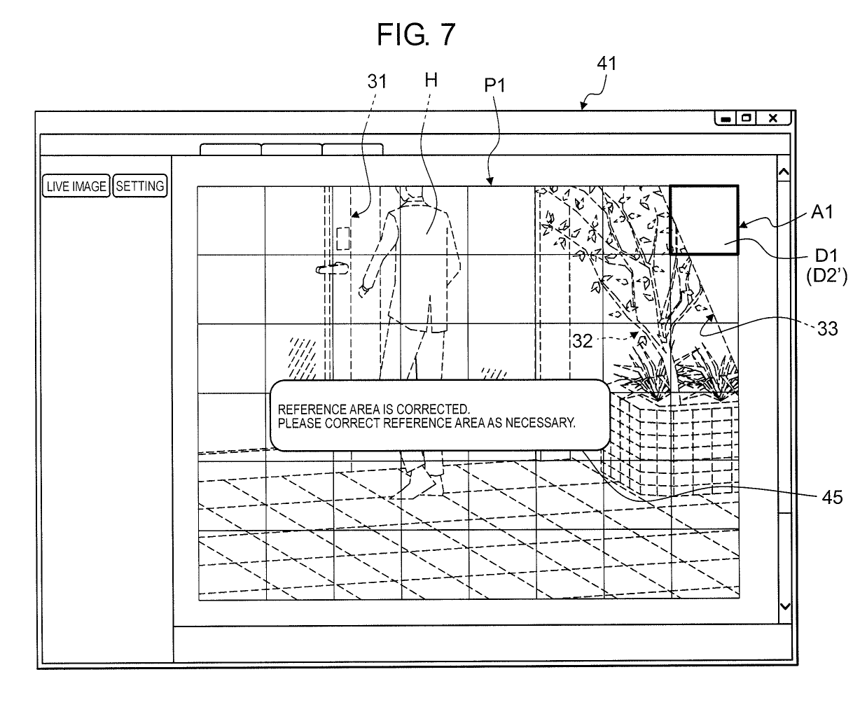

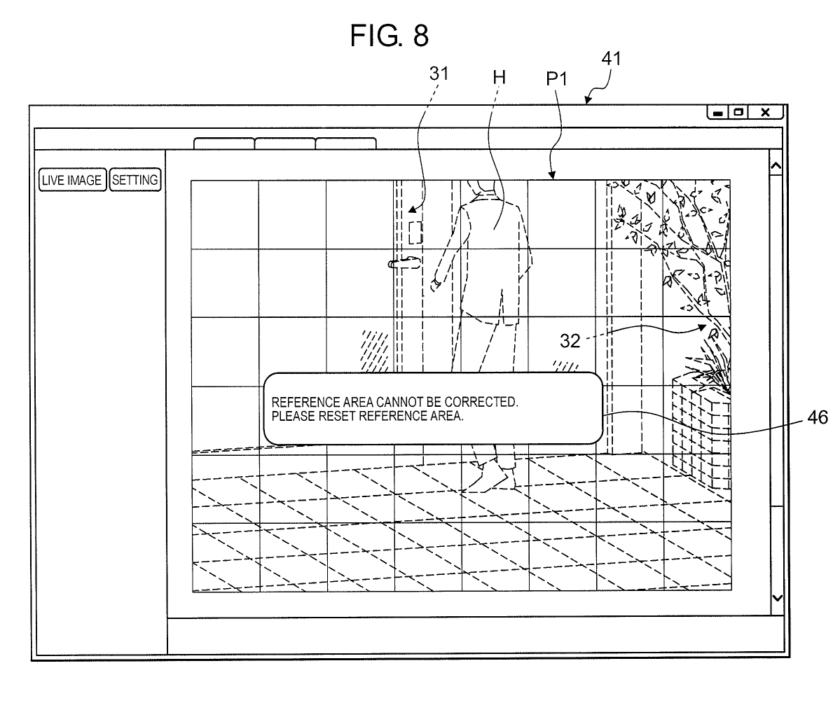

FIG. 5 is an explanatory diagram illustrating an example of a change in reference area A0, FIG. 6 is an explanatory diagram illustrating a correction result (replacement area A1) of reference area A0, FIG. 7 is an explanatory diagram illustrating an example of a method for notifying a user of correction of reference area A0 (setting of replacement area A1), and FIG. 8 is an explanatory diagram illustrating an example of a method for notifying a user of resetting of reference area A0.

As illustrated in FIG. 5, when unintended viewing angle deviation occurs in monitoring camera 2, displacement occurs in initial (that is, normal) reference area A0 illustrated in FIG. 3. The displacement is relative displacement of reference area A0 with respect to the still object within the imaging range. More specifically, FIG. 5 illustrates an example, in which viewing angle deviation occurs since a direction (imaging direction) of monitoring camera 2 moves slightly downward as compared with a direction of monitoring camera 2 in FIG. 3 and a position (imaging target) of a part (denoted by reference numeral D1′ in FIG. 5) of initial reference area illustrated in FIG. 3 (denoted by reference numeral A0′ in FIG. 5) is moved outside current captured image P1. As a result, in FIG. 5, in division area D1 (corresponding to division area D2 illustrated in FIG. 3 (indicated by reference numeral D2′ in FIG. 5)) of reference area A0, pillar 33 still occupies most of division area D1. On the other hand, in division area D2 of reference area A0, foliage plant 32 other than pillar 33 and window glass behind foliage plant 32 occupy a large area.

Therefore, change detector 23 detects displacement of reference area A0 based on displacement of pillar 33 which exists in reference area A0 illustrated in FIG. 3. Here, change detector 23 can estimate a displacement amount (motion vector) of reference area A0 based on a displacement amount of pillar 33. Thereby, as illustrated in FIG. 6, area setter 21 can set replacement area A1 for replacing reference area A0 based on the displacement amount of reference area A0. In this case, replacement area A1 is set to include at least one division area of initial reference area A0, and in here, is configured with division area D2 including pillar 33 included in initial reference area A0 illustrated in FIG. 3. Thereby, after replacement area A1 is set, exposure controller 22 can execute exposure control with reference to replacement area A1.

In this manner, when replacement area A1 for exposure control is set by area setter 21, notifier 24 notifies a user that reference area A0 is corrected. For example, as illustrated in FIG. 7, notifier 24 can cause screen display 45 to be displayed so as to be superimposed on captured image P1 of operation window 41, screen display 45 for notification to a user(here, a message indicating that reference area A0 is corrected (replacement area A1 is set)). In addition, instead of screen display 45 as illustrated in FIG. 7 (alternatively, together with screen display 45), notifier 24 can output a sound for notification to a user, from a speaker provided in portable terminal 5 or PC 4. Alternatively, notifier 24 may perform notification to a user by transmitting a mail to PC 4 or mobile terminal 5 of a user.

As another method, monitoring camera 2 may execute known face authentication processing based on the captured image, accumulate data on the number of authentication, compare current data with previous data, and determine that a change in the reference area occurs in a case where a variation in data (for example, a variation in the number of authentication per unit period) is large. In this case, monitoring camera 2 may perform display or notification indicating that displacement of the reference area occurs and that it is necessary to reset the reference area, for a user.

Depending on an amount and a direction of the viewing angle deviation occurred in monitoring camera 2, there is a case where a still object (in this case, pillar 33) which exists in initial reference area A0 completely comes out of captured image P0 (that is, pillar 33 entirely deviates from the imaging range). Alternatively, this is similar to a case where a still object which exists in initial reference area A0 disappears (is removed). In such a case, since it is difficult to appropriately set replacement area A1, area setter 21 does not set replacement area A1, and notifier 24 can cause, for example. as illustrated in FIG. 8, screen display 46 to be displayed so as to be superimposed on captured image P0 of operation window 41, screen display 46 for notification to a user (here, a message indicating that reference area A0 cannot be corrected (a message indicating that replacement area A1 cannot be set)). Notifier 24 may output a sound similarly to the above-described case.

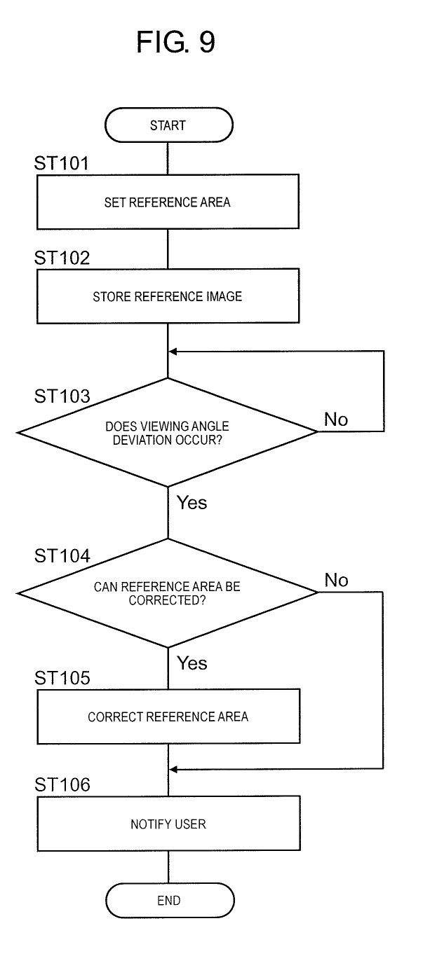

FIG. 9 is a flowchart illustrating a flow of correction processing of reference area A0 in monitoring camera system 1. In monitoring camera 2, first, when reference area A0 is set by a user (ST 101), a captured image at the initial viewing angle is stored as a reference image (ST 102).

When a viewing angle deviation occurs in monitoring camera 2 (Yes in ST 103), it is determined whether or not reference area A0 can be corrected based on a position of a predetermined still object (displacement amount) (ST 104). In a case where reference area A0 can be corrected in step ST 104 (Yes), correction of reference area A0 (that is, setting of replacement area A1) is executed (ST 105), and a user is notified of a fact indicating that reference area A0 is corrected, by screen display or sound output (ST 106).

On the other hand, in a case where reference area A0 cannot be corrected in step ST 104 (No), correction of reference area A0 is not executed, and a user is notified of a fact indicating that reference area A0 cannot be corrected (it is necessary to reset reference area A0), by screen display or sound output (ST 106).

As described above, in monitoring camera system 1, in a case where a change in reference area A0 is detected, exposure control is executed with reference to replacement area A1. Thus, even in a case where a deviation occurs in reference area A0 for exposure control that is set in a part of the imaging range due to an unintended viewing angle deviation, it is possible to appropriately execute exposure control.

### Second Embodiment

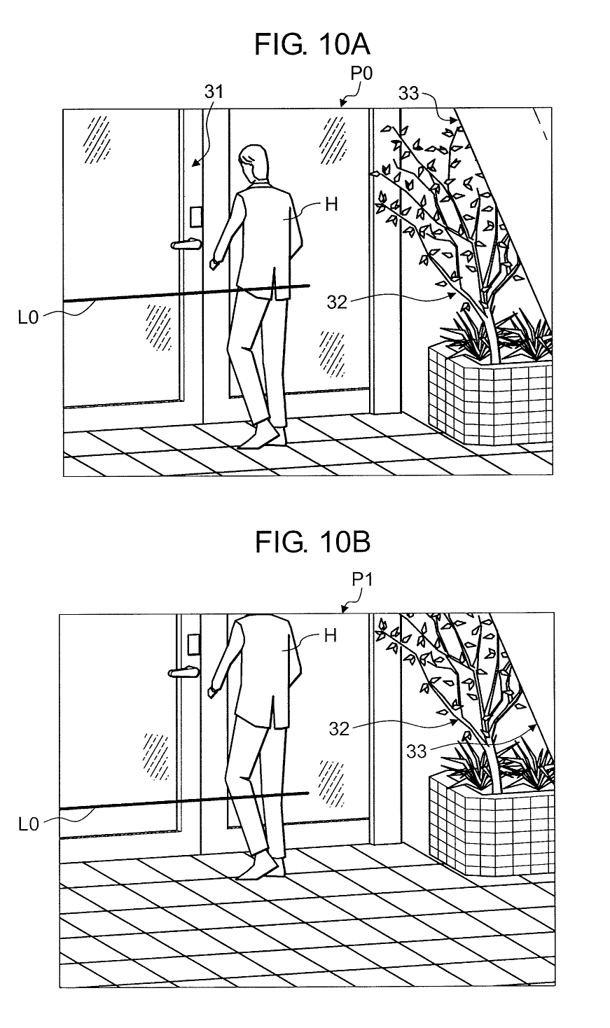

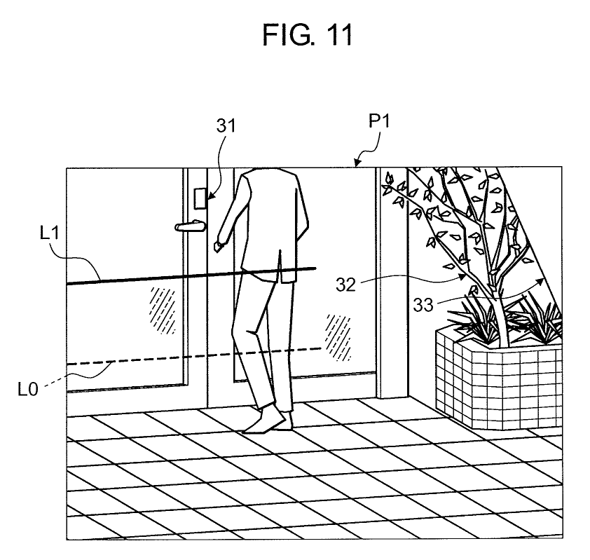

FIG. 10A and FIG. 10B are explanatory diagrams illustrating states before and after a change of reference line L0 which is set in an imaging range of monitoring camera 2 according to a second embodiment. FIG. 11 is an explanatory diagram illustrating a correction result of reference line L0 (replacement line L1). In monitoring camera system 1 according to the second embodiment, it is assumed that matters which are not particularly mentioned below are the same as those in the first embodiment. In addition, in FIG. 10A, FIG. 10B, and FIG. 11, the same reference numerals are given to elements similar to those in the first embodiment.

As illustrated in FIG. 10A, in monitoring camera 2 according to the second embodiment, reference line L0 for determining passage of person H (moving object) on captured image P0 (that is, in imaging range) can be set by a known technique. By counting the number of persons passing through reference line L0, it is possible to recognize the number of persons H entering (or leaving) from door 31. Here, since reference line L0 is disposed at a predetermined position in the imaging range, when an unintended viewing angle deviation occurs in monitoring camera 2, as illustrated in FIG. 10B, reference line L0 is displaced from an initial position illustrated in FIG. 10A (reference line L0 is relatively displaced with respect to a still object such as door 31). This may not be suitable for determining passage of person H.

Change detector 23 detects a change in reference area A0 as in the case of the first embodiment, and thus, as illustrated in FIG. 11, area setter 21 can set replacement line L1 for replacing reference line L0 based on a change degree (here, displacement amount) of reference area A0. Alternatively, change detector 23 detects displacement of reference line L0 based on, for example, displacement of a preset reference object (for example, a lower frame of door 31), and thus, area setter 21 can set replacement line L1 as illustrated in FIG. 11.

Even in the present embodiment, as in the first embodiment, monitoring camera 2 may accumulate data on the number of persons who pass reference line L0 (for example, the number of persons per unit time), compare current data with previous data, and determine that displacement of reference line L0 occurs in a case where a variation in data is large (for example, in a case where the number of persons passing through reference line L0 is greatly decreased by more than a predetermined threshold). Alternatively, monitoring camera 2 may execute known face authentication processing for person H, accumulate data on the number of authentication, compare current data with previous data, and determine that displacement of reference line L0 occurs in a case where a variation in data (for example, a variation in the number of authentication per unit period) is large. In this case, monitoring camera 2 may perform display or notification indicating that displacement of reference line L0 occurs and that it is necessary to reset reference line L0, for a user.

In this manner, in monitoring camera system 1 according to the second embodiment, even in a case where a deviation occurs in reference line L0 for determining passage of person H due to a viewing angle deviation, it is possible to appropriately determine passage of a moving object based on replacement line L1. In addition, it is also possible to use correction of reference area A0 according to the first embodiment together with correction of reference line L0 according to the second embodiment. Further, it is also possible to perform control so as to enable either one of correction of reference area A0 and correction of reference line L0 based on a basic setting (not illustrated) by a user's operation.

As described above, although the present disclosure has been described based on specific embodiments, these embodiments have been presented by way of example only, and the present disclosure is not limited by these embodiments. In the monitoring camera according to the present disclosure described in the above-described embodiments and the monitoring camera system including the monitoring camera, each element is not necessarily essential, and may be appropriately selected without at least departing from the scope of the present disclosure.

### INDUSTRIAL APPLICABILITY

The monitoring camera according to the present disclosure and the monitoring camera system including the monitoring camera can appropriately execute exposure control even in a case where a deviation occurs in the reference area for exposure control that is set in a part of the imaging range due to an unintended viewing angle deviation and is useful for a monitoring camera having an exposure control function and for a monitoring camera system including the monitoring camera.

### REFERENCE MARKS IN THE DRAWINGS

1 MONITORING CAMERA SYSTEM

2 MONITORING CAMERA

4 PC (INFORMATION DEVICE)

5 MOBILE TERMINAL (INFORMATION DEVICE)

11 IMAGING UNIT

15 IMAGE PROCESSING UNIT

16 IMAGE STORAGE UNIT

21 AREA SETTER

22 EXPOSURE CONTROLLER

23 CHANGE DETECTOR

24 NOTIFIER

32 PILLAR (STILL OBJECT)

A0 REFERENCE AREA

A1 REPLACEMENT AREA

D1, D2 DIVISION AREA

H PERSON (MOVING OBJECT)

L0 REFERENCE LINE

L1 REPLACEMENT LINE

P0 CAPTURED IMAGE

1. A monitoring camera having an exposure control function, comprising:
an exposure controller that executes exposure control by referring to a reference area which is set in a part of an imaging range;
a change detector that detects a change in the reference area; and
an area setter that sets a replacement area for replacing the reference area in a case where a change in the reference area is detected,
wherein the exposure controller executes the exposure control by referring to the replacement area in a case where the replacement area is set.

2. The monitoring camera of claim 1,
wherein the change detector detects a change in the reference area based on a change of a still object which exists as an object in the reference area.

3. The monitoring camera of claim 2,
wherein the change of the still object is displacement of the still object in the imaging range, and
wherein the area setter sets the replacement area based on the displacement of the still object.

4. The monitoring camera of claim 3,
wherein the area setter sets the replacement area only in a case where at least a part of the still object exists in the imaging range.

5. The monitoring camera of claim 1, further comprising:
an image storage unit that stores a reference image obtained by capturing a state before the change in the reference area,
wherein the change detector detects a change in the reference area based on a difference between pixel values of a current captured image and the reference image.

6. The monitoring camera of claim 1,
wherein a plurality of division areas are set in the imaging range, and
wherein the reference area is configured with one or more division areas selected based on a user operation.

7. The monitoring camera of claim 1, further comprising:
a notifier that prompts a user to reset the reference area in a case where a change in the reference area is detected and the replacement area is not set by the area setter.

8. The monitoring camera of claim 1,
wherein a reference line for determining passage of a moving object is set in the imaging range, and
wherein the area setter sets a replacement line for replacing the reference line in a case where a change in the reference area is detected.

9. A monitoring camera system comprising:
the monitoring camera of claim 1; and
an information device that is used for a setting operation by a user to the monitoring camera.
